(19) United States
(12) Patent Application Publication
(10) Pub. No.: US 2023/0093598 A1
(43) Pub. Date: Mar. 23, 2023

(54) SYSTEM AND METHOD FOR IMPLEMENTING A STANDARDIZE CONTEXT IDENTIFIER MODULE

(71) Applicant: JPMorgan Chase Bank, N.A., New York, NY (US)

(72) Inventors: Sudheer Kumar JAMI, (US); Anupam BANSAL, Jersey City, NJ (US); James TRAIT, Landenberg, PA (US); Emre OGUZ, Short Hills, NJ (US); Viktoria FREUD, Brooklyn, NY (US); Vishakarajan RAJENDRAN, Jersey City, NJ (US); Sunil NAIR, River Vale, NJ (US); Murari S CHOLAPPADI, Montclair, NJ (US); George I BRANDMAN, Larchmont, NY (US)

(73) Assignee: JPMorgan Chase Bank, N.A., New York, NY (US)

(21) Appl. No.: 17/448,264

(22) Filed: Sep. 21, 2021

(51) Int. Cl. G06Q 20/38; G06Q 20/40

(52) U.S. Cl. CPC G06Q 20/3821; G06Q 20/401; G06Q 20/381; G06Q 20/389

(57) ABSTRACT

A system and method for creating a context identifier are disclosed. A receiver receives a request from a user of an application to book a transaction corresponding to a security instrument. A processor accesses a database that stores security details data in connection with the security instrument at an instrument level via an instrument identifier (ID) internal to the application and stores the security details data at a trading line level via a trading line ID internal to the application. The processor pre-positions creation of a context ID within the instrument ID at a time of creation of the instrument ID; creates the context ID within the instrument ID independently of availability of external ID external to the application; completes booking of the transaction based on the context ID; and stores the context ID onto a security data master.

### TECHNICAL FIELD

This disclosure generally relates to data processing, and, more particularly, to methods and apparatuses for implementing a standardize context identifier module that generates a standardize context identifier that is not dependent on external identifier (ID) value, thereby allowing subscribers of an application to move away from external ID dependency to book transactions.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

ISIN (International Securities Identification Number), SEDOL (Stock Exchange Daily Official List), and CUSIP (Committee on Uniform Securities Identification Procedures) numbers are commonly used to uniquely identify investments.

For example, an ISIN is a 12-digit alphanumeric code that uniquely identifies a specific security. The organization that allocates ISINs in any particular country is the country's respective National Numbering Agency (NNA). ISIN is a list of security identifiers used in the United Kingdom and Ireland for clearing purposes.

SEDOLs serve as the National Securities Identifying Number for all securities issued in the United Kingdom and are therefore part of the security's ISIN as well. All SEDOL codes have seven characters, split into two parts: the first six characters are an alphanumeric code, and the seventh character is a trailing check digit. Within the alphanumeric part, letters from B to Z are allowed while numbers from 0 to 9 are allowed as numerals. The SEDOL Masterfile (SMF) provides reference data on millions of global multi-asset securities each uniquely identified at the market level using a universal SEDOL code, much like an ISIN identifies a security.

A CUSIP (Committee on Uniform Securities Identification Procedures) is a nine-digit numeric or nine-character alphanumeric code that identifies a North American financial security for the purposes of facilitating clearing and settlement of trades.

The conventional identifiers may be applicable to one granular level that may work for a section of business functionalities, but not for other functionalities, such as a combination of settlement functions and clearing functions, etc. Different functionalities have different granular identifier requirements and, today, there is no standardized identifier that can address this issue.

### SUMMARY

The present disclosure, through one or more of its various aspects, embodiments, and/or specific features or sub-components, provides, among other features, various systems, servers, devices, methods, media, programs, and platforms for implementing a standardize context identifier module that generates a standardize identifier that is not dependent on external identifier (ID) value, thereby allowing subscribers of an application to move away from external ID dependency to book transactions, but the disclosure is not limited thereto.

According to an aspect of the present disclosure, a method for creating a context identifier by utilizing one or more processors and one or more memories is disclosed. The method may include: receiving a request from a user of an application to book a transaction corresponding to a security instrument; accessing a database that stores security details data in connection with the security instrument at an instrument level via an instrument identifier (ID) internal to the application and stores the security details data at a trading line level via a trading line ID internal to the application; pre-positioning creation of a context ID within the instrument ID at a time of creation of the instrument ID; creating the context ID within the instrument ID independently of availability of external ID external to the application; completing booking of the transaction based on the context ID; and storing the context ID onto a security data master.

According to another aspect of the present disclosure, the instrument ID may represent the security instrument in the security data master and may hold issuance's terms and conditions related information data;

According a further aspect of the present disclosure, the trading line ID may be provided within the instrument ID and may represent the security instrument in a specific exchange and may holds its listing related information data, but the disclosure is not limited thereto.

According to an additional aspect of the present disclosure, the context ID may represent the security instrument in a predefined market and currency, but the disclosure is not limited thereto. The predefined market may be a country where the user wants to trade corresponding to the booked transaction, but the disclosure is not limited thereto.

According to yet another aspect of the present disclosure, the method may further include: receiving input data from the user via the application, wherein the input data corresponds to a combination of country and currency data that are not already available on the security data master; and creating the context ID based on the received input data.

According to another aspect of the present disclosure, the method may further include determining whether duplicate context ID with the same country and currency is already being created or not by searching stored context IDs on the security data master; and when it is determined that no duplicate context ID is already being created, creating the context ID based on the received input data.

According to an additional aspect of the present disclosure, the context ID created for an instrument ID may not reused or moved to another instrument ID.

According to a further aspect of the present disclosure, the method may further include implementing a checking algorithm to ensure that context ID attribute values for the created context ID are not modified; and creating a new context ID with a new combination of attribute values, wherein the attribute values may include country data and currency data for a particular transaction.

According to another aspect of the present disclosure, the method may further include creating a normalized data model where the context ID is linked to global level instrument ID.

According to yet another aspect of the present disclosure, the method may further include implementing a centralized instrument symbology mapping service; and implementing a navigation capability between the context ID and the external ID by utilizing the centralized instrument symbology mapping service.

According to a further aspect of the present disclosure, the method may further include implementing a centralized instrument symbology mapping service; and implementing a navigation capability between the context ID and other internal IDs including internal upstream or downstream applications by utilizing the centralized instrument symbology mapping service.

According to another aspect of the present disclosure, the centralized instrument symbology mapping service may include any commonly used symbology mapping service as desired by a user which may enable a seller side firm to offer trading, risk management, clearing and settlement services to a buyer side, irrespective of the product choice that a buyer side client has made, but the disclosure is not limited thereto.

According to another aspect of the present disclosure, a system for creating a context identifier is disclosed. The system may include: a processor; and a memory operatively connected to the processor via a communication interface, the memory storing computer readable instructions, when executed, causes the processor to: receive a request from a user of an application to book a transaction corresponding to a security instrument; access a database that stores security details data in connection with the security instrument at an instrument level via an instrument identifier (ID) internal to the application and stores the security details data at a trading line level via a trading line ID internal to the application; pre-position creation of a context ID within the instrument ID at a time of creation of the instrument ID; create the context ID within the instrument ID independently of availability of external ID external to the application; complete booking of the transaction based on the context ID; and store the context ID onto a security data master.

According to yet another further aspect of the present disclosure, the processor may be further configured to receive input data from the user via the application, wherein the input data corresponds to a combination of country and currency data that are not already available on the security data master; and create the context ID based on the received input data.

According to a further aspect of the present disclosure, the processor may be further configured to determine whether duplicate context ID with the same country and currency is already being created or not by searching stored context IDs on the security data master; and when it is determined that no duplicate context ID is already being created, create the context ID based on the received input data.

According to an additional aspect of the present disclosure, the processor may be further configured to implement a checking algorithm to ensure that context ID attribute values for the created context ID are not modified; and create a new context ID with a new combination of attribute values, wherein the attribute values may include country data and currency data for a particular transaction, but the disclosure is not limited thereto.

According to a further aspect of the present disclosure, the processor may be further configured to create a normalized data model where the context ID is linked to global level instrument ID.

According to yet another aspect of the present disclosure, the processor may be further configured to implement a centralized instrument symbology mapping service; and implement a navigation capability between the context ID and the external ID by utilizing the centralized instrument symbology mapping service.

According to a further aspect of the present disclosure, the processor may be further configured to implement a centralized instrument symbology mapping service; and implement a navigation capability between the context ID and other internal IDs including internal upstream or downstream applications by utilizing the centralized instrument symbology mapping service.

According to yet another aspect of the present disclosure, a non-transitory computer readable medium configured to store instructions for assigning a single use real-time privilege is disclosed. The instructions, when executed, may cause a processor to: receive a request from a user of an application to book a transaction corresponding to a security instrument; access a database that stores security details data in connection with the security instrument at an instrument level via an instrument identifier (ID) internal to the application and stores the security details data at a trading line level via a trading line ID internal to the application; pre-position creation of a context ID within the instrument ID at a time of creation of the instrument ID; create the context ID within the instrument ID independently of availability of external ID external to the application; complete booking of the transaction based on the context ID; and store the context ID onto a security data master.

According to an additional aspect of the present disclosure, the instructions, when executed, may further cause the processor to receive input data from the user via the application, wherein the input data corresponds to a combination of country and currency data that are not already available on the security data master; and create the context ID based on the received input data.

According to a further aspect of the present disclosure, the instructions, when executed, may further cause the processor to determine whether duplicate context ID with the same country and currency is already being created or not by searching stored context IDs on the security data master; and when it is determined that no duplicate context ID is already being created, create the context ID based on the received input data.

According to an additional aspect of the present disclosure, the instructions, when executed, may further cause the processor to implement a checking algorithm to ensure that context ID attribute values for the created context ID are not modified; and create a new context ID with a new combination of attribute values, wherein the attribute values may include country data and currency data for a particular transaction, but the disclosure is not limited thereto.

According to a further aspect of the present disclosure, t the instructions, when executed, may further cause the processor to create a normalized data model where the context ID is linked to global level instrument ID.

According to yet another aspect of the present disclosure, the instructions, when executed, may further cause the processor to implement a centralized instrument symbology mapping service; and implement a navigation capability between the context ID and the external ID by utilizing the centralized instrument symbology mapping service.

According to a further aspect of the present disclosure, the instructions, when executed, may further cause the processor to implement a centralized instrument symbology mapping service; and implement a navigation capability between the context ID and other internal IDs including internal upstream or downstream applications by utilizing the centralized instrument symbology mapping service.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a standardize context identifier module that generates a standardize context identifier in accordance with an exemplary embodiment.

FIG. 2 illustrates an exemplary diagram of a network environment with a standardize context identifier device in accordance with an exemplary embodiment.

FIG. 3 illustrates a system diagram for implementing a standardize context identifier device with a standardize context identifier module in accordance with an exemplary embodiment.

FIG. 4 illustrates a system diagram for implementing a standardize context identifier module of FIG. 3 in accordance with an exemplary embodiment.

FIG. 5 illustrates a flow chart of creating context identifier implemented by the standardize context identifier module of FIG. 4 in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

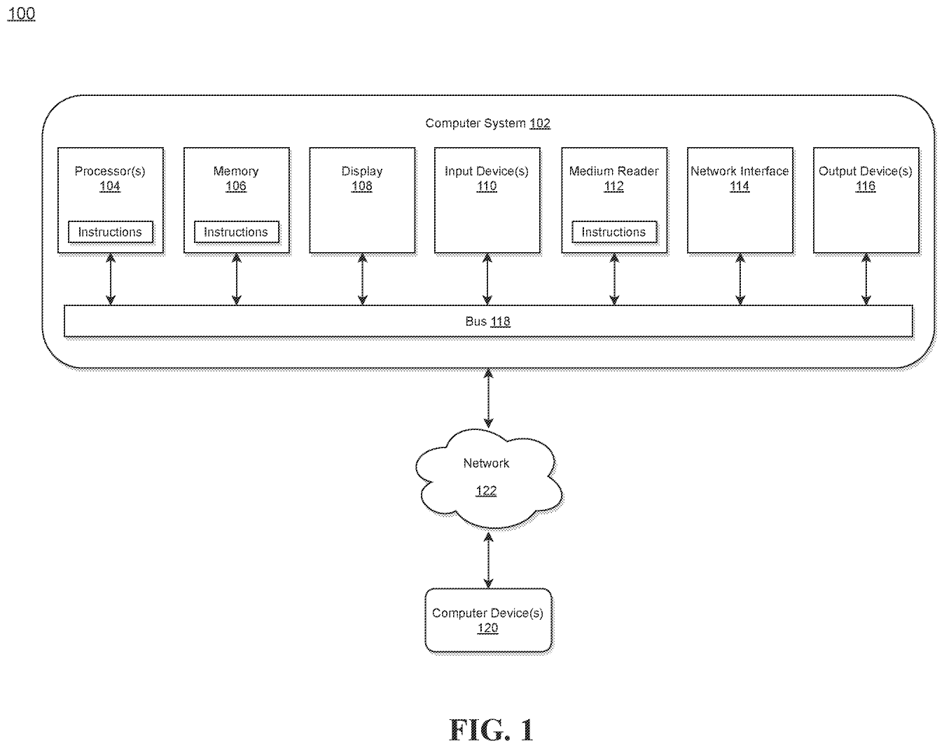

FIG. 1 is an exemplary system for use in implementing a standardize context identifier module that generates a standardize context identifier in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

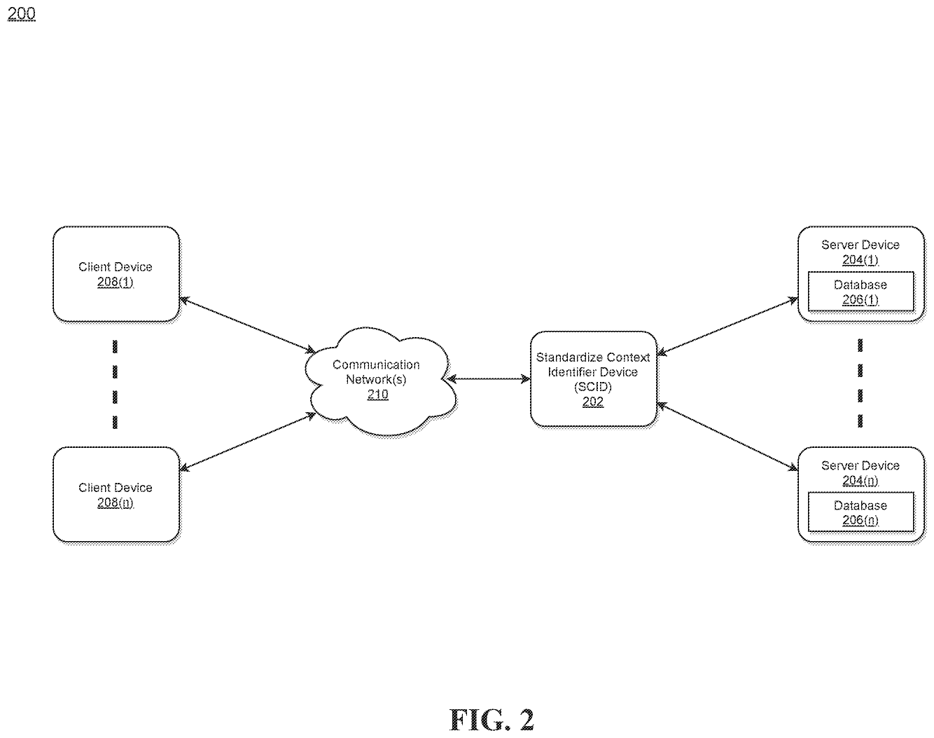

Referring to FIG. 2, a schematic of an exemplary network environment 200 for implementing a standardize context identifier device (SCID) for creating a standardize context identifier of the instant disclosure is illustrated.

According to exemplary embodiments, the above-described problems associated with conventional approach may be overcome by implementing an SCID 202 as illustrated in FIG. 2 that may provide a platform for implementing a standardize context identifier module that generates a standardize identifier that is not dependent on external identifier (ID) value, thereby allowing subscribers of an application to move away from external ID dependency to book transactions, but the disclosure is not limited thereto.

The SCID 202 may be the same or similar to the computer system 102 as described with respect to FIG. 1.

The SCID 202 may store one or more applications that can include executable instructions that, when executed by the SCID 202, cause the SCID 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SCID 202 itself, may be located in virtual server(s) running in a cloud-based computing environment rather than being tied to one or more specific physical network computing devices. Also, the application(s) may be running in one or more virtual machines (VMs) executing on the SCID 202. Additionally, in one or more embodiments of this technology, virtual machine(s) running on the SCID 202 may be managed or supervised by a hypervisor.

In the network environment 200 of FIG. 2, the SCID 202 is coupled to a plurality of server devices 204(1)-204(n) that hosts a plurality of databases 206(1)-206(n), and also to a plurality of client devices 208(1)-208(n) via communication network(s) 210. A communication interface of the SCID 202, such as the network interface 114 of the computer system 102 of FIG. 1, operatively couples and communicates between the SCID 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SCID 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SCID 202 may be a standalone device or integrated with one or more other devices or apparatuses, such as one or more of the server devices 204(1)-204(n), for example. In one particular example, the SCID 202 may be hosted by one of the server devices 204(1)-204(n), and other arrangements are also possible. Moreover, one or more of the devices of the SCID 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SCID 202 via the communication network(s) 210 according to the HTTP-based and/or JavaScript Object Notation (JSON) protocol, for example, although other protocols may also be used. According to a further aspect of the present disclosure, wherein the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the SCID 202 that may efficiently provide a platform for implementing a standardize context identifier module that generates a standardize identifier that is not dependent on external identifier (ID) value, thereby allowing subscribers of an application to move away from external ID dependency to book transactions, but the disclosure is not limited thereto.

The client devices 208(1)-208(n) may run interface applications, such as standard web browsers or standalone client applications, which may provide an interface to communicate with the SCID 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SCID 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SCID 202, the server devices 204(1)-204(n), or the client devices 208(1)-208(n), for example, may be configured to operate as virtual instances on the same physical machine. For example, one or more of the SCID 202, the server devices 204(1)-204(n), or the client devices 208(1)-208(n) may operate on the same physical device rather than as separate devices communicating through communication network(s) 210. Additionally, there may be more or fewer SCIDs 202, server devices 204(1)-204(n), or client devices 208(1)-208(n) than illustrated in FIG. 2. According to exemplary embodiments, the SCID 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof

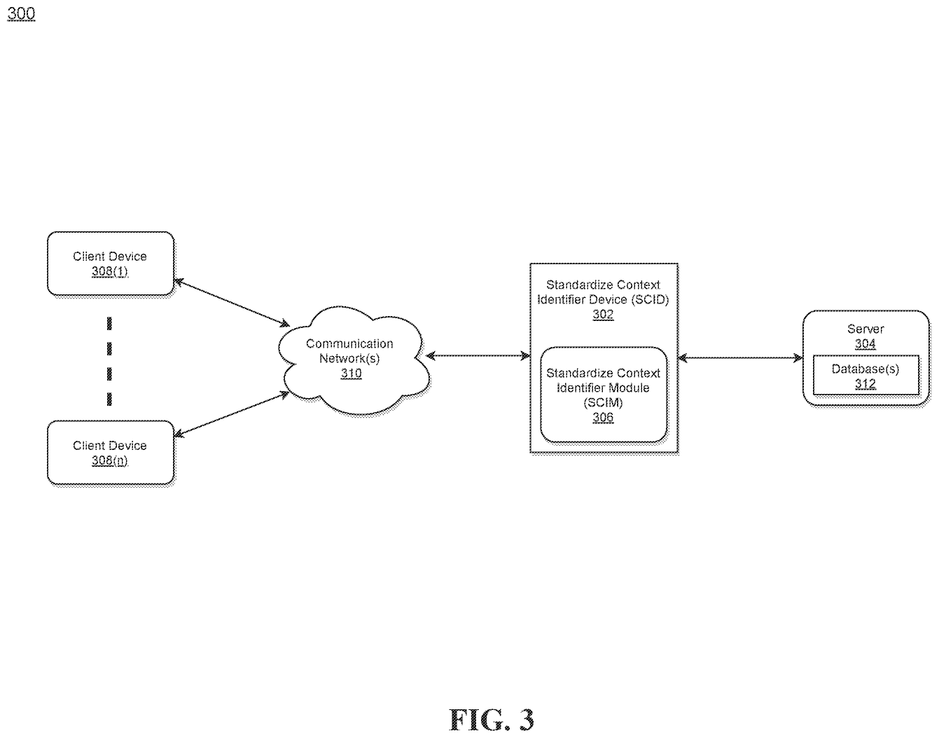

FIG. 3 illustrates a system diagram for implementing an SCID having a standardize context identifier module (SCIM) that can create a standardize context identifier in accordance with an exemplary embodiment.

As illustrated in FIG. 3, the system 300 may include an SCID 302 within which an SCIM 306 is embedded, a server 304 which may include a database(s) 312, a plurality of client devices 308(1). . . 308(n), and a communication network 310.

According to exemplary embodiments, the SCID 302 including the SCIM 306 may be provided between the server 304 that includes the database(s) 312 and the communication network 310. Although there is only one database has been illustrated, the disclosure is not limited thereto. Any number of databases may be utilized. The SCID 302 may also be connected to the plurality of client devices 308(1). . . 308(n) via the communication network 310, but the disclosure is not limited thereto.

According to exemplary embodiment, the SCID 302 is described and shown in FIG. 3 as including the SCIM 306, although it may include other rules, policies, modules, databases, or applications, for example. According to exemplary embodiments, the database(s) 312 may be embedded within the SCID 302. According to exemplary embodiments, the database(s) 312 may be configured to store configuration details data corresponding to a desired data to be fetched from one or more data sources, user information data, security details data in connection with the security instrument at an instrument level via an instrument identifier (ID) internal to the application, security details data at a trading line level via a trading line ID internal to the application etc., but the disclosure is not limited thereto.

According to exemplary embodiments, the SCIM 306 may be configured to receive real-time feed of data from the plurality of client devices 308(1). . . 308(n) via the communication network 310.

According to exemplary embodiments, as will be described below, the SCIM 306 may be configured to receive a request from a user of an application to book a transaction corresponding to a security instrument; access a database that stores security details data in connection with the security instrument at an instrument level via an instrument identifier (ID) internal to the application and stores the security details data at a trading line level via a trading line ID internal to the application; pre-position creation of a context ID within the instrument ID at a time of creation of the instrument ID; create the context ID within the instrument ID independently of availability of external ID external to the application; complete booking of the transaction based on the context ID; and store the context ID onto a security data master, but the disclosure is not limited thereto.

The plurality of client devices 308(1). . . 308(n) are illustrated as being in communication with the SCID 302. In this regard, the plurality of client devices 308(1). . . 308(n) may be “clients” of the SCID 302 and are described herein as such. Nevertheless, it is to be known and understood that the plurality of client devices 308(1). . . 308(n) need not necessarily be “clients” of the SCID 302, or any entity described in association therewith herein. Any additional or alternative relationship may exist between either or both of the plurality of client devices 308(1). . . 308(n) and the SCID 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1). . . 308(n) may communicate with the SCID 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SCID 302 may be the same or similar to the SCID 202 as described with respect to FIG. 2, including any features or combination of features described with respect thereto.

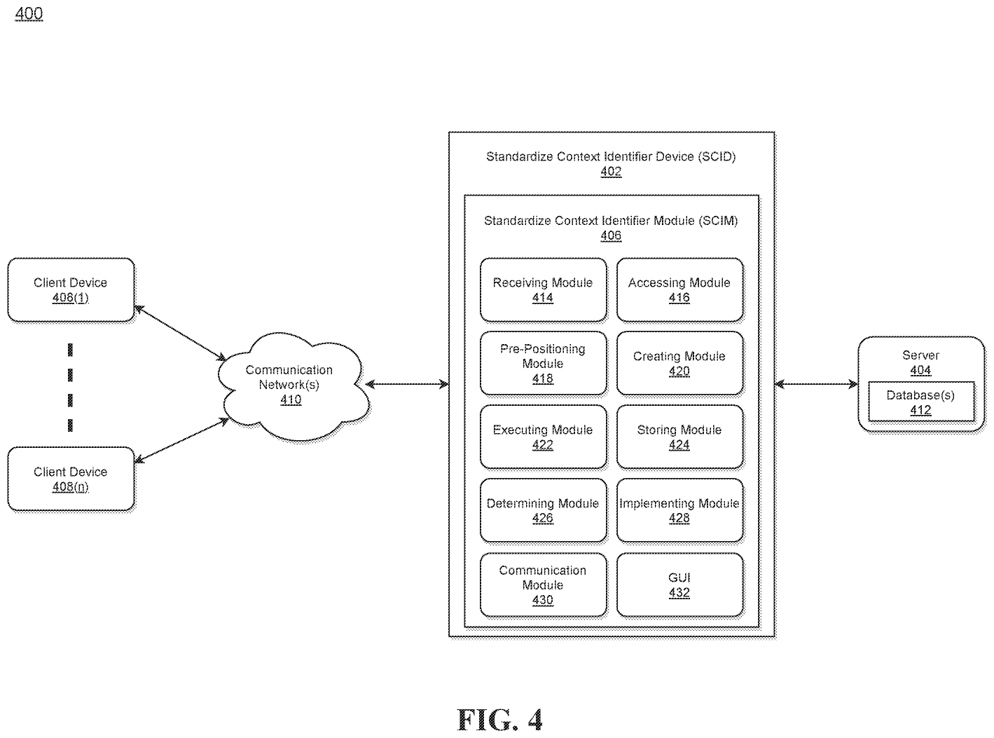

FIG. 4 illustrates a system diagram for implementing a standardize context identifier module (SCIM) of FIG. 3 that can create a standardize context identifier for a security instrument in accordance with an exemplary embodiment.

According to exemplary embodiments, the system 400 may include a standardize context identifier device (SCID) 402 within which a standardize context identifier module (SCIM) 406 is embedded, a server 404 that includes a database(s) 412, and a communication network 410.

According to exemplary embodiments, the SCID 402 including the SCIM 406 may be provided between the server 404 that includes the database(s) 412 and the communication network 410. The SCID 402 may also be connected to the plurality of client devices 408(1) . . . 408(n) via the communication network 410, but the disclosure is not limited thereto. According to exemplary embodiments, the SCID 402, the SCIM 406, the database(s) 412, the server 404, the client devices 408(1)-408(n), and the communication network 410 as illustrated in FIG. 4 may be the same or similar to the SCID 302, the SCIM 306, the database(s) 312, the server 304, the client devices 308(1)-308(n), and the communication network 310, respectively, as illustrated in FIG. 3.

According to exemplary embodiments, as illustrated in FIG. 4, the SCIM 406 may include a receiving module 414, an accessing module 416, a pre-positioning module 418, a creating module 420, an executing module 422, a storing module 424, a determining module 426, an implementing module 428, a communication module 430, and a graphical user interface (GUI) 432.

According to exemplary embodiments, each of the receiving module 414, accessing module 416, pre-positioning module 418, creating module 420, executing module 422, storing module 424, determining module 426, implementing module 428, and the communication module 430 may be implemented by microprocessors or similar, they may be programmed using software (e.g., microcode) to perform various functions discussed herein and may optionally be driven by firmware and/or software. Alternatively, each of the receiving module 414, accessing module 416, pre-positioning module 418, creating module 420, executing module 422, storing module 424, determining module 426, implementing module 428, and the communication module 430 may be implemented by dedicated hardware, or as a combination of dedicated hardware to perform some functions and a processor (e.g., one or more programmed microprocessors and associated circuitry) to perform other functions. Also, according to exemplary embodiments, each of the receiving module 414, accessing module 416, pre-positioning module 418, creating module 420, executing module 422, storing module 424, determining module 426, implementing module 428, and the communication module 430 may be physically separated into two or more interacting and discrete blocks, units, devices, and/or modules without departing from the scope of the inventive concepts.

According to exemplary embodiments, each of the receiving module 414, accessing module 416, pre-positioning module 418, creating module 420, executing module 422, storing module 424, determining module 426, implementing module 428, and the communication module 430 may be called by corresponding API, but the disclosure is not limited thereto.

The process may be executed via the communication module 430 and the communication network 410, which may comprise plural networks as described above. For example, in an exemplary embodiment, the various components of the SCIM 406 may communicate with the server 404, and the database(s) 412 via the communication module 430 and the communication network 410. Of course, these embodiments are merely exemplary and are not limiting or exhaustive.

According to exemplary embodiments, the communication network 410 and the communication module 430 may be configured to establish a link between the database(s) 412, the client devices 408(1)-408(n) and the SCIM 406.

According to exemplary embodiments, the receiving module 414 may be configured to receive a request from a user of an application to book a transaction corresponding to a security instrument.

According to exemplary embodiments, the accessing module 416 may be configured to access the database(s) 412 that stores security details data in connection with the security instrument at an instrument level via an instrument identifier (ID) internal to the application and stores the security details data at a trading line level via a trading line ID internal to the application.

According to exemplary embodiments, the pre-positioning module 418 may be configured to pre-position creation of a context ID within the instrument ID at a time of creation of the instrument ID.

According to exemplary embodiments, the creating module 420 may be configured to create the context ID within the instrument ID independently of availability of external ID external to the application.

According to exemplary embodiments, the executing module 422 may be configured to complete booking of the transaction based on the context ID and the storing module 424 may be configured to store the context ID onto a security data master. According to exemplary embodiments, the security data master may be configured to implement a computer-implemented program that combines bits and pieces of the best data about a financial instrument and then store the best data in the database(s) 412. The stored data then may be accessible to users and applications. According to exemplary embodiments, the instrument ID may represent the security instrument in the security data master and may hold issuance's terms and conditions related information data.

According to exemplary embodiments, the trading line ID may be provided within the instrument ID and may represent the security instrument in a specific exchange and may holds its listing related information data, but the disclosure is not limited thereto.

According to exemplary embodiments, the context ID may represent the security instrument in a predefined market and currency, but the disclosure is not limited thereto. The predefined market may be a country where the user wants to execute trade corresponding to the booked transaction, but the disclosure is not limited thereto.

According to exemplary embodiments, the receiving module 414 may be further configured to receive input data from the user via the application. The input data may correspond to a combination of country and currency data that are not already available on the security data master. The creating module 420 may be configured to create the context ID based on the received input data.

According to exemplary embodiments, the determining module 426 may be configured to determine whether duplicate context ID with the same country and currency is already being created or not by searching stored context IDs on the security data master; and when it is determined that no duplicate context ID is already being created, the creating module 420 may be configured to create the context ID based on the received input data.

According to exemplary embodiments, the context ID created for an instrument ID may not reused or moved to another instrument ID.

According to exemplary embodiments, the implementing module 428 may be configured to implement a checking algorithm to ensure that context ID attribute values for the created context ID are not modified; and the creating module 420 may be configured to create a new context ID with a new combination of attribute values, wherein the attribute values may include country data and currency data for a particular transaction, but the disclosure is not limited thereto. It should be understood by a skilled artisan that any known checking algorithm may be implemented by the SCIM 406 without departing from the scope of the present disclosure.

According to exemplary embodiments, the creating module 420 may be further configured to create a normalized data model where the context ID may be linked to global level instrument ID.

According to exemplary embodiments, the implementing module 428 may be configured to implement a centralized instrument symbology mapping service; and implement a navigation capability between the context ID and the external ID by utilizing the centralized instrument symbology mapping service. It should be understood by a skilled artisan that any known navigation capability may be implemented by the SCIM 406 without departing from the scope of the present disclosure.

According to exemplary embodiments, the implementing module 428 may be configured to implement a centralized instrument symbology mapping service; and implementing a navigation capability between the context ID and other internal IDs including internal upstream or downstream applications by utilizing the centralized instrument symbology mapping service. According to exemplary embodiments, the centralized instrument symbology mapping service may include any commonly known symbology mapping service as desired by a user, without departing from the scope of the present disclosure, which may enable a seller side firm to offer trading, risk management, clearing and settlement services to a buyer side, irrespective of the product choice that a buyer side client has made, but the disclosure is not limited thereto.

According to exemplary embodiments, the context ID created by the crating module 420 may be persisted throughout the life of the security for a given instrument ID. The SCIM 406 may be configured to support a new context ID generation to address asset servicing scenarios.

According to exemplary embodiments, the context ID may be available in production for fixed income, equity, rights, warrants, futures, options and for active and inactive assets, but the disclosure is not limited thereto.

Exemplary usage of context ID may include one or more of the following: trade booking, clearing, settlement, risk and position management, asset servicing, client reporting, valuation, analytics, etc., but the disclosure is not limited thereto

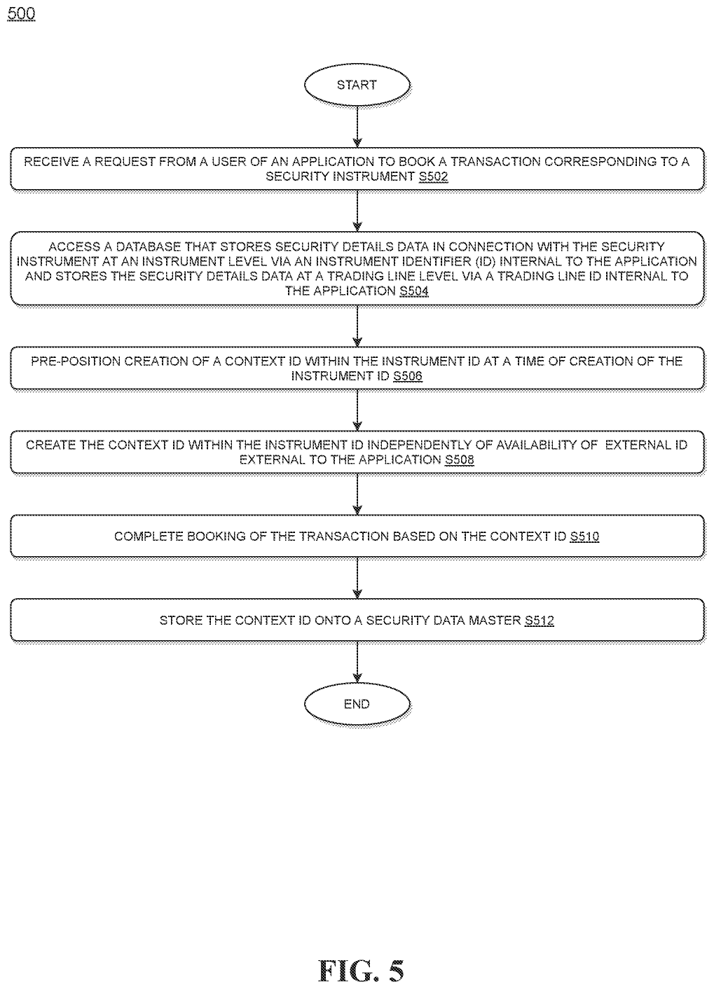

FIG. 5 illustrates a flow chart of a process 500 implemented by the SCIM 406 of FIG. 4 for creating context identifier in accordance with an exemplary embodiment. It will be appreciated that the illustrated process 500 and associated steps may be performed in a different order, with illustrated steps omitted, with additional steps added, or with a combination of reordered, combined, omitted, or additional steps.

As illustrated in FIG. 5, at step 502, the process 500 may include receiving a request from a user of an application to book a transaction corresponding to a security instrument.

At step 504, the process 500 may include accessing a database that stores security details data in connection with the security instrument at an instrument level via an instrument ID internal to the application and stores the security details data at a trading line level via a trading line ID internal to the application.

At step 506, the process 500 may include pre-positioning creation of a context ID within the instrument ID at a time of creation of the instrument ID.

At step 508, the process 500 may include creating the context ID within the instrument ID independently of availability of external ID external to the application.

At step 510, the process 500 may include completing booking of the transaction based on the context ID.

At step 512, the process 500 may include storing the context ID onto a security data master.

According to exemplary embodiments, the process 500 may further include receiving input data from the user via the application, wherein the input data corresponds to a combination of country and currency data that are not already available on the security data master; and creating the context ID based on the received input data.

According to exemplary embodiments, the process 500 may further include determining whether duplicate context ID with the same country and currency is already being created or not by searching stored context IDs on the security data master; and when it is determined that no duplicate context ID is already being created, creating the context ID based on the received input data.

According to exemplary embodiments, the process 500 may further include implementing a checking algorithm to ensure that context ID attribute values for the created context ID are not modified; and creating a new context ID with a new combination of attribute values, wherein the attribute values may include country data and currency data for a particular transaction.

According to exemplary embodiments, the process 500 may further include creating a normalized data model where the context ID is linked to global level instrument ID.

According to exemplary embodiments, the process 500 may further include implementing a centralized instrument symbology mapping service; and implementing a navigation capability between the context ID and the external ID by utilizing the centralized instrument symbology mapping service.

According to exemplary embodiments, the process 500 may further include implementing a centralized instrument symbology mapping service; and implementing a navigation capability between the context ID and other internal IDs including internal upstream or downstream applications by utilizing the centralized instrument symbology mapping service.

According to exemplary embodiments, the SCID 402 may include a memory (e.g., a memory 106 as illustrated in FIG. 1) which may be a non-transitory computer readable medium that may be configured to store instructions for implementing an SCIM 406 for creating a context identifier as disclosed herein. The SCID 402 may also include a medium reader (e.g., a medium reader 112 as illustrated in FIG. 1) which may be configured to read any one or more sets of instructions, e.g., software, from any of the memories described herein. The instructions, when executed by a processor embedded within the SCIM 406 or within the SCID 402, may be used to perform one or more of the methods and processes as described herein. In a particular embodiment, the instructions may reside completely, or at least partially, within the memory 106, the medium reader 112, and/or the processor 104 (see FIG. 1) during execution by the SCID 402.

According to exemplary embodiments, the instructions, when executed, may cause the processor 104 to perform the following: receiving a request from a user of an application to book a transaction corresponding to a security instrument; accessing a database that stores security details data in connection with the security instrument at an instrument level via an instrument identifier (ID) internal to the application and stores the security details data at a trading line level via a trading line ID internal to the application; pre-positioning creation of a context ID within the instrument ID at a time of creation of the instrument ID; creating the context ID within the instrument ID independently of availability of external ID external to the application; completing booking of the transaction based on the context ID; and storing the context ID onto a security data master.

According to exemplary embodiments, the instructions, when executed, may further cause the processor 104 to perform the following: receiving input data from the user via the application, wherein the input data corresponds to a combination of country and currency data that are not already available on the security data master; and creating the context ID based on the received input data.

According to exemplary embodiments, the instructions, when executed, may further cause the processor 104 to perform the following: determining whether duplicate context ID with the same country and currency is already being created or not by searching stored context IDs on the security data master; and when it is determined that no duplicate context ID is already being created, creating the context ID based on the received input data.

According to exemplary embodiments, the instructions, when executed, may further cause the processor 104 to perform the following: implementing a checking algorithm to ensure that context ID attribute values for the created context ID are not modified; and creating a new context ID with a new combination of attribute values, wherein the attribute values may include country data and currency data for a particular transaction.

According to exemplary embodiments, the instructions, when executed, may further cause the processor 104 to perform the following: creating a normalized data model where the context ID is linked to global level instrument ID.

the instructions, when executed, may further cause the processor 104 to perform the following: implementing a centralized instrument symbology mapping service; and implementing a navigation capability between the context ID and the external ID by utilizing the centralized instrument symbology mapping service.

According to exemplary embodiments, the instructions, when executed, may further cause the processor 104 to perform the following: implementing a centralized instrument symbology mapping service; and implementing a navigation capability between the context ID and other internal IDs including internal upstream or downstream applications by utilizing the centralized instrument symbology mapping service.

According to exemplary embodiments as disclosed above in FIGS. 1-6, technical improvements effected by the instant disclosure may include a platform for implementing a standardize context identifier module that generates a standardize identifier that is not dependent on external identifier (ID) value, thereby allowing subscribers of an application to move away from external ID dependency to book transactions, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for creating a context identifier by utilizing one or more processors and one or more memories, the method comprising:
receiving a request from a user of an application to book a transaction corresponding to a security instrument;
accessing a database that stores security details data in connection with the security instrument at an instrument level via an instrument identifier (ID) internal to the application and stores the security details data at a trading line level via a trading line ID internal to the application;
pre-positioning creation of a context ID within the instrument ID at a time of creation of the instrument ID;
creating the context ID within the instrument ID independently of availability of external ID external to the application;
completing booking of the transaction based on the context ID; and
storing the context ID onto a security data master.

2. The method according to claim 1, wherein the instrument ID represents the security instrument in the security data master and holds issuance's terms and conditions related information data.

3. The method according to claim 1, wherein the trading line ID is provided within the instrument ID and represents the security instrument in a specific exchange and holds its listing related information data.

4. The method according to claim 1, wherein the context ID represents the security instrument in a predefined market and currency.

5. The method according to claim 4, wherein the predefined market is a country where the user wants to trade corresponding to the booked transaction.

6. The method according to claim 1, further comprising:
receiving input data from the user via the application, wherein the input data corresponds to a combination of country and currency data that are not already available on the security data master; and
creating the context ID based on the received input data.

7. The method according to claim 6, further comprising:
determining whether duplicate context ID with the same country and currency is already being created or not by searching stored context IDs on the security data master; and
when it is determined that no duplicate context ID is already being created, creating the context ID based on the received input data.

8. The method according to claim 1, wherein the context ID created for an instrument ID is not reused or moved to another instrument ID.

9. The method according to claim 1, further comprising:
implementing a checking algorithm to ensure that context ID attribute values for the created context ID are not modified; and
creating a new context ID with a new combination of attribute values.

10. The method according to claim 9, wherein the attribute values include country data and currency data for a particular transaction.

11. The method according to claim 1, further comprising:
creating a normalized data model where the context ID is linked to global level instrument ID.

12. The method according to claim 1, further comprising:
implementing a centralized instrument symbology mapping service; and
implementing a navigation capability between the context ID and the external ID by utilizing the centralized instrument symbology mapping service.

13. The method according to claim 1, further comprising:
implementing a centralized instrument symbology mapping service; and
implementing a navigation capability between the context ID and other internal IDs including internal upstream or downstream applications by utilizing the centralized instrument symbology mapping service.

14. A system for creating a context identifier, the system comprising:
a processor; and
a memory operatively connected to the processor via a communication interface, the memory storing computer readable instructions, when executed, causes the processor to:
receive a request from a user of an application to book a transaction corresponding to a security instrument;
access a database that stores security details data in connection with the security instrument at an instrument level via an instrument identifier (ID) internal to the application and stores the security details data at a trading line level via a trading line ID internal to the application;
pre-position creation of a context ID within the instrument ID at a time of creation of the instrument ID;
create the context ID within the instrument ID independently of availability of external ID external to the application;
complete booking of the transaction based on the context ID; and
store the context ID onto a security data master.

15. The system according to claim 14, wherein:
the instrument ID represents the security instrument in the security data master and holds issuance's terms and conditions related information data;
the trading line ID is provided within the instrument ID and represents the security instrument in a specific exchange and holds its listing related information data;
the context ID represents the security instrument in a predefined market and currency;
the predefined market is a country where the user wants to trade corresponding to the booked transaction; and
the context ID created for an instrument ID is not reused or moved to another instrument ID.

16. The system according to claim 14, wherein the processor is further configured to:
receive input data from the user via the application, wherein the input data corresponds to a combination of country and currency data that are not already available on the security data master; and
create the context ID based on the received input data.

17. The system according to claim 16, wherein the processor is further configured to:
determine whether duplicate context ID with the same country and currency is already being created or not by searching stored context IDs on the security data master; and
when it is determined that no duplicate context ID is already being created, create the context ID based on the received input data.

18. The system according to claim 14, wherein the processor is further configured to:
implement a checking algorithm to ensure that context ID attribute values for the created context ID are not modified; and
create a new context ID with a new combination of attribute values, wherein the attribute values include country data and currency data for a particular transaction.

19. The system according to claim 14, wherein the processor is further configured to:
create a normalized data model where the context ID is linked to global level instrument ID;
implement a centralized instrument symbology mapping service;
implement a navigation capability between the context ID and the external ID by utilizing the centralized instrument symbology mapping service; and
implement the navigation capability between the context ID and other internal IDs including internal upstream or downstream applications by utilizing the centralized instrument symbology mapping service.

20. A non-transitory computer readable medium configured to store instructions for creating a context identifier wherein, when executed, the instructions cause a processor to perform the following:
receiving a request from a user of an application to book a transaction corresponding to a security instrument;
accessing a database that stores security details data in connection with the security instrument at an instrument level via an instrument identifier (ID) internal to the application and stores the security details data at a trading line level via a trading line ID internal to the application;
pre-positioning creation of a context ID within the instrument ID at a time of creation of the instrument ID;
creating the context ID within the instrument ID independently of availability of external ID external to the application;
completing booking of the transaction based on the context ID; and
storing the context ID onto a security data master.
